(19) United States
(12) Patent Application Publication
(10) Pub. No.: US 2008/0302207 A1
(43) Pub. Date: Dec. 11, 2008

(54) CRANKSHAFT

(75) Inventors: Paul Breidenbach, Bechenheim (DE); Frank Hilger, Karben (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/134,064

(22) Filed: Jun. 5, 2008

(30) Foreign Application Priority Data
Jun. 6, 2007 (DE) 102007026371.8

(51) Int. Cl. F16C 3/06

(52) U.S. Cl. 74/595

(57) ABSTRACT

A crankshaft, in particular to be developed as part of an internal combustion engine of a motor vehicle, with at least one main bearing for connecting the crankshaft with an engine block, wherein the main bearing is developed at least partly, so that the axial border areas of the main bearing are convexly opposite the mid-section of the main bearing configured between the axial border areas, and/or with at least one large end bearing to connect the crankshaft with a connecting rod, wherein the large end bearing is at least partially developed so that the axial border areas of the large end bearings are convexly opposite the mid-section of the large end bearing, configured between the axial border areas. Through that it is possible to increase the stiffness of the crankshaft, without the need to alter the fittings on the main bearing and/or on the large end bearing.

### CROSS-REFERENCE TO RELATED APPLICATION

This application claims priority to German Patent Application No. 102007026371.8, filed Jun. 6, 2007, which is incorporated herein by reference in its entirety.

### TECHNICAL FIELD

The technical field relates to a crankshaft, and more particularly to a crankshaft configured for an internal combustion engine of a motor vehicle.

### BACKGROUND

Well-known crankshafts preferably comprise two or more main bearings, through which the crankshaft is connected to an engine block. Furthermore, along the crankshaft, between every two crankwebs, a large end bearing is provided through which the crankshaft is connected to a connecting rod.

In order, for example, to enhance the cylinder capacity of the crankshaft configuration, the distance between the center of the large end bearing and the center of the crankshaft, the so-called crank radius, is enlarged. When the diameter of the bearings is not simultaneously enlarged, the stiffness of the crankshaft is lessened.

In order to compensate for the loss of stiffness in the crankshaft, the use of correspondingly bigger dimensioned cylindrically formed main and/or large end bearings is well known; however, this requires a great and cost-intensive effort in which particularly the corresponding components such as the crankshaft, engine block, bearing shells and/or connecting rods to which the larger dimensioned main- and/or large end bearing must be adjusted. Moreover, the distance must be changed between the fittings on the main bearings and/or on the large end bearings due to the corresponding increase in the dimensions of the bearings, requiring, in turn, higher manufacturing and assembly effort and, through that, an increase in costs.

In view of the foregoing, it is at least one object to provide measures through which the stiffness of the crankshaft can be enhanced without the need to change the fittings on the main bearing and/or on the large end bearing. In addition, other objects, desirable features, and characteristics will become apparent from the subsequent summary and detailed description and the appended claims, taken in conjunction with the accompanying drawings and this background.

### SUMMARY

According to an exemplary embodiment of the invention, the crankshaft includes, but is not limited to, particularly in configuration for use in an internal combustion engine of a motor vehicle, at least one main bearing to connect the crankshaft with an engine block, wherein the main bearing is at least partially developed so that the axial border areas of the main bearing are convexly opposite the mid-section of the main bearing between the axial border areas. Furthermore, the crankshaft can include, but is not limited to at least one large end bearing to connect the crankshaft with a connecting rod, wherein the large end bearing is at least partially developed so that the axial border areas of the large end bearing are convexly opposite the mid-section between the axial border areas.

As a result of the fact that in the main bearing and/or the large end bearing, the axial border areas are convexly opposite the mid-section of the bearing configured between the axial border areas, the crankshaft will attain a high degree of stability and stiffness; at the same time the cylinder capacity is increased. For this, the position of the bolts used for fitting the connecting rods to the crankshaft or for connecting the engine blocks to the crankshaft need not be altered in further manufacturing operations; because of this, the alterations in manufacturing and assembly costs will be significantly reduced.

The highest stress on the bearings occurs in the transfer at the edges, particularly on the crankwebs. As a result, in that the main bearing and/or the large end bearing in particular now comprise at least partially concave recesses, the axial border areas of the bearings, as opposed to the mid sections of the bearing between the axial border areas, are strengthened so that the position of the fittings, in particular the fitting distance, does not need to be altered. Consequently, the main bearing and/or the large end bearing do not comprise, according to an exemplary embodiment of the invention, a cylindrical form, but are planned with a concave recess. The center area is preferably in the middle of the bearing, in which the bearing comprises the smallest diameter.

Further, the tensions at the axial border areas are reduced because of the concave recess of the bearings.

If only a minimal amount of stress is placed on the crankshaft, the contact surface between the main bearing and the engine block and/or the contact surface between the large end bearing and the connecting rod is reduced, whereby, because of the reduced friction surface, less friction and, as a result, minimal wear and tear on the contact surfaces can be achieved.

Moreover, a reduction in fuel consumption can be achieved due to minimal friction.

Preferably, the diameter of the axial border areas of the main bearing comprises a ratio to the diameter of the middle area of the main bearing of at least 23/21 and/or the diameter of the axial border areas of the large end bearing to the diameter of the middle area of the large end bearing comprises a ratio of 23/21. The diameter of the middle area of the bearing is preferably measured in the center of the bearing where the bearing comprises the smallest diameter. As a result of the ratio of the diameter of the axial border area to the diameter of the middle area being at least 23/21, a particularly high stiffness of the crankshaft is achieved.

Further, the axial border areas of the main bearing preferably comprise a bigger clearance than the middle area of the large end bearing. As a result, only the center area of the bearings is burdened particularly in the case of minimal impact on the bearings; in this way, friction also only occurs in the center area. As a result, an advantageous reduction in fuel consumption can be achieved.

It is preferable that the main bearing and/or the large end bearing are produced through a machining process such as grinding or cutting. Using a machining process in the production of the bearings, in particular the concave recesses of the bearings, a precise fitting becomes possible, through which the desired roundness of each recess can be achieved simply. Moreover, the roughness of the surface of the bearing is reduced, through which the frictional resistance between the surface of the bearing and the engine block and/or the connecting rod is as minimal as possible.

An embodiment of the invention further concerns a connecting rod for connecting a crankshaft with a piston which leads through a cylinder particularly of the internal combustion engine of a motor vehicle, wherein the crankshaft can be developed and improved as mentioned above. The piston rod comprises, in accordance with an exemplary embodiment of the invention, a connecting rod and a connecting rod cover, wherein a connecting rod end is formed in the transition area between the connecting rod and the connecting rod cover; the inner shape of the connecting rod end comprises at least partially a convex recess.

The inner shape of the connecting rod end of the convex recess is bent outwardly, so that the center area of the bearing arches across from both axial border areas of the bearing, wherein the diameter of the center area, in particular the diameter in the center of the bearing, is smaller than the diameter of the axial border areas of the bearing.

Preferably, the convex recess encroaches on a, as mentioned above, developed and improved large-end bearing. At the same time, the convex recess of the connecting rod end is adjusted to the concave recess of the large-end bearing, so that the connecting rod can be led evenly on the large end bearing, or on the crankshaft.

### BRIEF DESCRIPTION OF THE DRAWINGS

The present invention will hereinafter be described in conjunction with the following drawing figure, and

FIG. 1 is a schematic view of a crankshaft configuration with a large end bearing, according to an exemplary the invention.

### DETAILED DESCRIPTION

The following detailed description is merely exemplary in nature and is not intended to limit the application and uses. Furthermore, there is no intention to be bound by any theory presented in the preceding summary or background or the following detailed description.

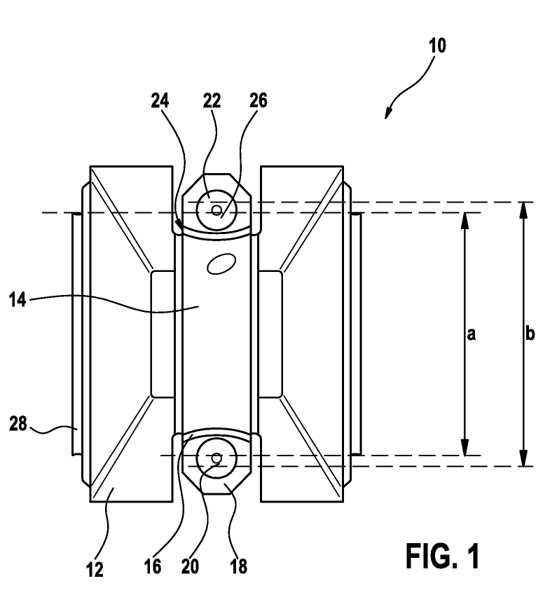

The crankshaft configuration 10 displayed in FIG. 1 comprises two crankwebs 12. Between the two crankwebs 12, a large end bearing 14 is located. On the contact surface of the large end bearings 14, a bearing shell 16 is configured in a sliding way. The bearing shell 16 is in turn solidly connected to the piston rod and the connecting cover of a connecting rod 18. In the transition area between the piston rod and the connecting cover, a connecting rod end is formed, through which the large end bearing 14 of the crankshaft is led. The piston rod and the connecting cover are joined together with two bolts 20, 22. The large end bearing 14 as well as the bearing shell 16 comprise a concave recess, for which the axial border areas 24 opposite from the mid-section 26 between the axial border areas 24 are domed. At the same time, the curve of the bearing shell 16 preferably is adjusted to the curve, bow, of the large end bearing 14.

On the other hand the connecting rod 18, within the inner contour of the connecting rod end, comprises a convex recess where the mid-section of the connecting rod is outwardly curved as opposed to the large end bearing 14 so that the convex recess of the connecting rod end can reach into the concave recess of the large end bearing 14.

Further, FIG. 1 displays the different spacing of the fittings a, b bolts 20, 22, which connect the piston rod with the connecting cover, depending on whether the large end bearing is developed in a cylindrical form or comprises a concave form. As a result, it can be recognized that the fitting distance a, in the concave recess of a large end bearing of the fitting distance a, corresponds to a commonly used cylindrical recess of a large end bearing; for this reason it must not be changed if an increase of the cylinder capacity of the crank operation is to be achieved. If, however, an increase in the cylinder capacity is achieved through increasing the diameter of a cylindrical large end bearing, as opposed to the more commonly used cylindrical large end bearings, a fitting distance b will be necessary, which is arranged away from fitting a, so that the fitting can be adjusted to the larger dimension large end bearing with a high completion effort. This disadvantage will be avoided through the crankshaft or crankshaft configuration according to an exemplary embodiment of the invention.

On the opposite sides of the crankweb to the large end bearing, one main bearing 28, respectively, is configured, over which the crankshaft can be connected with the engine block. The main bearing 28 also comprises a concave recess, for which the axial border areas of the main bearing 28 opposite the mid-section of the main bearing is curved or domed.

The crankshaft according to an exemplary embodiment of the invention or crankshaft configuration will preferably be employed in internal combustion engines, for example, in internal combustion engines of motor vehicles. Nevertheless, it may also, if required, be employed in other machines.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A crankshaft for an internal combustion of a motor vehicle, comprising:
a main bearing configured to connect the crankshaft with an engine block; wherein the main bearing is at least partially configured such that axial border areas of the main bearing convexly opposite a mid-section of the main bearing is between the axial border areas; and
an end bearing configured to connect the crankshaft with a connecting rod, wherein the one end bearing is at least partially configured such that axial border areas of the end bearing convexly opposite the mid-section of the end bearing is between the axial border areas.

2. The crankshaft according to claim 1, wherein the diameter of the axial border areas of the main bearing comprises a ratio of at least 23/21 to the diameter of the middle area of the main bearing and the diameter of the axial border areas of the end bearing to the diameter of a middle area of the end bearing comprises a ratio of at least 23/21.

3. The crankshaft according to claim 1, wherein the axial border areas of the main bearing comprises a larger clearance than the mid-section of the main bearing.

4. The crankshaft according to claim 1, wherein the axial border areas of the end bearing comprises a larger clearance than the mid-section of the end bearing.

5. The crankshaft according to claim 1, wherein the main bearing is produced through a machining process.

6. The crankshaft according to claim 1, wherein the end bearing is produced through a machining process.
